(19) United States
(12) Patent Application Publication
(10) Pub. No.: US 2010/0099287 A1
(43) Pub. Date: Apr. 22, 2010

(54) BIDIRECTIONAL SOCKET

(76) Inventors: Eric R. Colburn, Wexford, PA (US); Michael Laskowski, Pittsburgh, PA (US); Juan C. Escobar, New York, NY (US); Ryan Vernon, New York, NY (US)

Correspondence Address: SEYFARTH SHAW LLP, 131 S. DEARBORN ST., SUITE 2400, CHICAGO, IL, 60603-5803, US

(21) Appl. No.: 12/573,018

(22) Filed: Oct. 2, 2009

Related U.S. Application Data
(60) Provisional application No. 61/195,020, filed on Oct. 2, 2008.
(60) Provisional application No. 61/270,747, filed on Jul. 13, 2009.

(51) Int. Cl. H01R 27/00

(52) U.S. Cl. 439/224

(57) ABSTRACT

An electrical socket is provided. The electrical socket includes a face, a first pair of plug receptacles and a second pair of plug receptacles. The first pair of plug receptacles is defined within the face and separated by a distance having a first center point. The first pair of plug receptacles is configured to provide an electrical connection to a power source. The second pair of plug receptacles is defined within the face, substantially perpendicular to the first pair of plug receptacles, and separated by a distance having a second center point. The second pair of plug receptacles is configured to provide an electrical connection to a power source. Further, the first and second center points are the same point.

### RELATED APPLICATIONS

The present application claims priority to U.S. Ser. No. 61/195,020 filed Oct. 2, 2008, and to U.S. Ser. No. 61/270,747 filed Jul. 13, 2009, the entire disclosures of which are hereby incorporated by reference.

### TECHNICAL FIELD OF THE INVENTION

The present device relates to an electrical socket. Particularly, the present device relates to a non-polarized bidirectional socket for charging electronic devices, such as cellular phones and personal MP3 players.

### BACKGROUND OF THE INVENTION

Faceplates and outlet configurations for electrical sockets, adapters, and power strips have, of course, been around since at least the inception of household electrical wiring. However, the growing presence and multiplication of electrical devices in nearly every modern household has spurred the improvement upon a common electrical outlet configuration to accommodate such devices. Despite these improvements, such as that disclosed in U.S. Pat. No. 7,347,724 to Crupi disclosing a multiple receptacle outlet to transform a standard electrical wall box, such multi-receptacle outlets are bulky and cumbersome and oftentimes confusing as to the manner in which plugs are to be inserted into the receptacles. This is particularly true where grounded and polarized receptacles are adapted to accommodate multiple devices requiring such safety features. However, many common devices such as cell phones, personal portable music devices, and digital cameras, do not require polarized receptacles or grounding configurations.

FIGS. 1 and 2 illustrate common disadvantages encountered by users attempting to plug a number of modern devices into existing outlet structures 144. In particular, elongated plugs and adapters 150 engaged in a first outlet 146 block neighboring outlets 148 from being utilized, thereby decreasing the effectiveness of the outlet design, requiring increased clearance and extra outlets, even though not all of the outlets will be accessible to a standard plug design. Additionally, standard wall outlets present similar problems when an elongated plug or adapter 150 is positioned in one outlet—many plug and outlet designs thereby render the neighboring free outlet inaccessible. One reason for this inconvenience is that standard outlet designs arrange sockets along a single axis 152, therefore automatically creating constraints for the manner in which a device plug 150 may be positioned in the outlet structure 144. The single axis 152 of the outlet 146, 148, combined with the orientation of devices plugs inevitably requires that sufficient spacing is permitted between outlets 146, 148, resulting in free neighboring outlets 148 being blocked.

Accordingly, there exists a need for a space-saving configuration for electrical sockets, and particularly for use in electric device chargers to accommodate one or a number of plugs for charging devices and in electrical adapters for compact, effective, and safe retention of one or more male plugs. The present invention solves these and other issues related to prior art devices by providing a bidirectional socket in several embodiments for enabling a selection of plug orientations to accommodate one or a series of non-polarized male plugs.

### SUMMARY OF THE INVENTION

In one form, an electrical socket is provided. The electrical socket includes a face, a first pair of plug receptacles and a second pair of plug receptacles. The first pair of plug receptacles is defined within the face and separated by a distance having a first center point. The first pair of plug receptacles is configured to provide an electrical connection to a power source. The second pair of plug receptacles is defined within the face, substantially perpendicular to the first pair of plug receptacles, and separated by a distance having a second center point. The second pair of plug receptacles is configured to provide an electrical connection to a power source. Further, the first and second center points are the same point.

According to one form, electrical power strip is provided. The electrical power strip includes a housing and a plurality of receptacle sets. The housing includes an outlet face and a male plug extending from the housing and is configured to provide an electrical connection to a power source. The plurality of receptacle sets each includes a first pair of plug receptacles and a second pair of plug receptacles. The first pair of plug receptacles is defined on the outlet face and separated by a distance having a first center point. The first pair of plug receptacles is configured to provide an electrical connection to the male plug. The second pair of plug receptacles is defined on the outlet face, substantially perpendicular to the first pair of plug receptacles, and separated by a second distance having a center point. The second pair of plug receptacles is configured to provide an electrical connection to the male plug. Further, the first and second center points are the same point.

In accordance with one form, an electrical socket is provided. The electrical socket includes a face, a first pair of plug receptacles and a second pair of plug receptacles. The first pair of plug receptacles is defined within the face, is oriented along a first axis and defines a first plug area. The first pair of plug receptacles is configured to provide an electrical connection to a power source. The second pair of plug receptacles is defined within the face, is oriented along a second axis and defines a second plug area. The second axis intersects the first axis. The second pair of plug receptacles is configured to provide an electrical connection to a power source. Further, the first plug area overlaps the second plug area.

According to one form, the first pair and the second pair of plug receptacles are non-polarized.

In one form, the electrical socket further includes a housing and a male plug. The face is coupled to the housing. The male plug is configured for insertion into a power outlet. The male plug is operably coupled to the housing for providing an electrical connection to the outlet and is electrically coupled to the first pair and second pair of plug receptacles.

In accordance with one form, the male plug is rotatable with respect to the housing to allow the socket to be oriented regardless of the power outlet configuration.

According to one form, the male plug is retractable to allow prongs of the plug to be collectively moved from an open and usable position to a closed position.

In one form, the electrical socket further includes wiring connectors electrically coupled to the first pair and second pair of plug receptacles for electrical wiring to a power source.

In accordance with one form, the first pair of plug receptacles and second pair of plug receptacles define a receptacle set, and wherein the face comprises a plurality of receptacle sets defined thereon.

According to one form, the plurality of sets are linearly arranged.

In one form, the plurality of sets are arranged in a block.

In accordance with one form, the electrical power strip is an adapter.

According to one form, the socket is an adapter comprising a male plug for insertion to a power outlet, the male plug being electrically coupled to the outlet.

In one form, the first axis is perpendicular to the second axis and the first plug area substantially overlaps the second plug area.

In accordance with one form, the first pair of plug receptacles and second pair of plug receptacles define a receptacle set, and wherein the face comprises a plurality of receptacle sets defined thereon.

These and other aspects of the invention may be understood more readily from the following description and the appended drawings.

### BRIEF DESCRIPTION OF THE DRAWINGS

For the purpose of facilitating an understanding of the subject matter sought to be protected, there are illustrated in the accompanying drawings embodiments thereof, from an inspection of which, when considered in connection with the following description, the subject matter sought to be protected, its construction and operation, and many of its advantages should be readily understood and appreciated.

FIG. 1 is a perspective view of a prior art outlets installed in a furniture structure;

FIG. 2 is a perspective view of a prior art electrical power strip;

FIG. 3 is a perspective view of a bidirectional socket;

FIG. 4 is a rear perspective view of a bidirectional charging station;

FIG. 5 is a schematic diagram of the electrical connections for a bidirectional socket;

FIG. 6 is a perspective view of one form of a block of bidirectional outlets;

FIG. 7A is a perspective view of one form of a bidirectional socket adapter being installed on a standard outlet;

FIG. 7B is a perspective view of the bidirectional socket adapter after being installed on a standard outlet;

FIG. 8 is a perspective view of one form of a plurality of bidirectional sockets on an electrical power strip;

FIG. 9 is a perspective view of one form of a plurality of bidirectional sockets installed on a furniture structure; and

FIG. 10 is a perspective view of the plurality of bidirectional sockets of FIG. 9 having device plugs installed thereon.

### DETAILED DESCRIPTION OF PREFERRED EMBODIMENTS

While this invention is susceptible of embodiments in many different forms, there is shown in the drawings and will herein be described in detail embodiments of the invention with the understanding that the present disclosure is to be considered as an exemplification of the principles of the invention and is not intended to limit the broad aspect of the invention to embodiments illustrated.

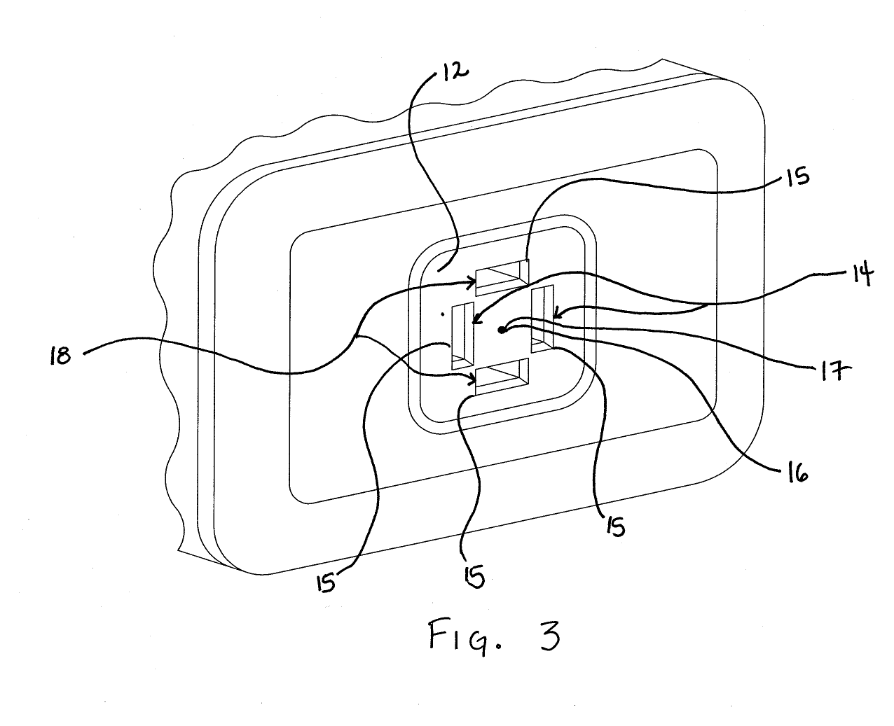

Referring to FIGS. 3-10, there is illustrated a variety of embodiments disclosing a bidirectional socket for providing multiple orientations for receiving male plug portions of a variety of devices. The socket is generally designated by the numeral 10. Most generally, the socket 10 comprises a face 12 to provide a surface for both supporting a male plug or device received by the socket 10 and enclosing and concealing the internal circuitry and wiring of the socket 10, as will be described and as is generally understood by those having ordinary skill in the art. The face 12 may be in the form of a standard electrical socket faceplate, or may take others forms, but has defined within it a first pair 14 of plug receptacles 15. A second pair 18 of plug receptacles 15 is defined in the face 12, as well.

As illustrated in FIG. 3, the multi-orientation feature of each of the embodiments of the present device is provided by the first pair 14 of plug receptacles 15 being separated by a distance having a first center point 16 equidistant between the receptacles 14. Similarly, the second pair 18 of plug receptacles 15 are defined in the face 12 with a center point 17 equidistant between the receptacles 15, with the first center point 16 of the first pair 14 of plug receptacles 15 being at the same position as the second center point 17 of the second pair 18. Additionally, in an embodiment, the first pair 14 and second pair 18 are substantially perpendicular to each other.

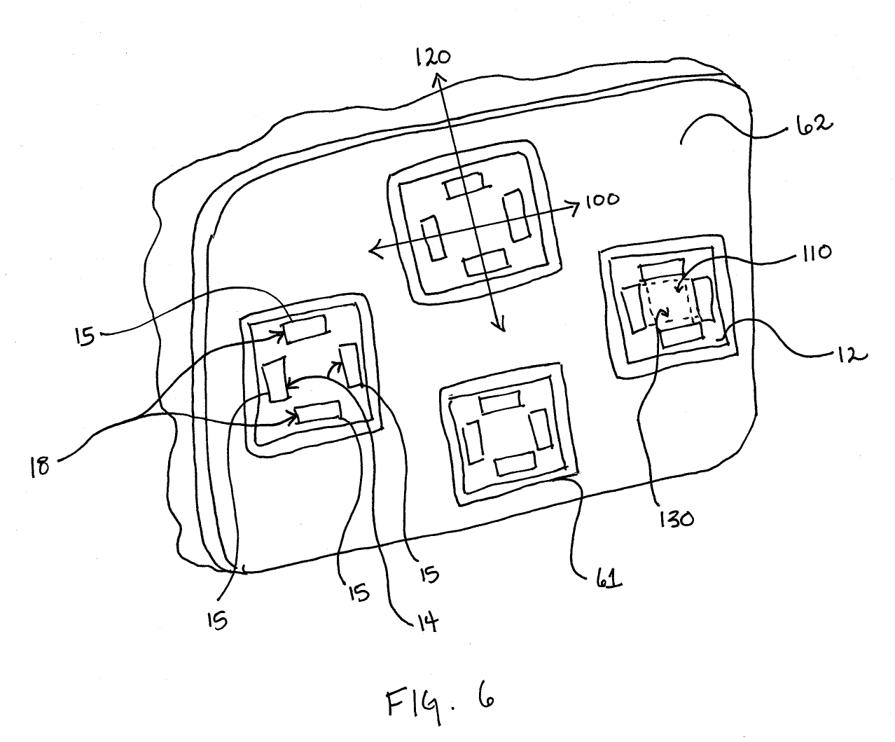

An embodiment of the socket 10 as illustrated in FIG. 6 discloses that the socket 10 may comprise, as previously described, a face 12 into which a first pair 14 of plug receptacles 15 is defined. The first pair 14 of plug receptacles 15 is oriented along a first axis 100 and defines a first plug area 110. Similarly, a second pair 18 of plug receptacles 15 is defined within the face 12 oriented along a second axis 120 and defining a second plug area 130. As seen in FIG. 6, the second axis 120 intersects the first axis 100, and the first plug area 110 may overlap the second plug area 130. In an embodiment, the first 100 and second 120 axes may be perpendicular to each other, and the first plug area 110 may substantially overlap the second plug area 130, as illustrated in FIG. 6. It is suggested, however, that persons having ordinary skill in the art would understand that alternative configurations providing the bidirectional functionality are possible.

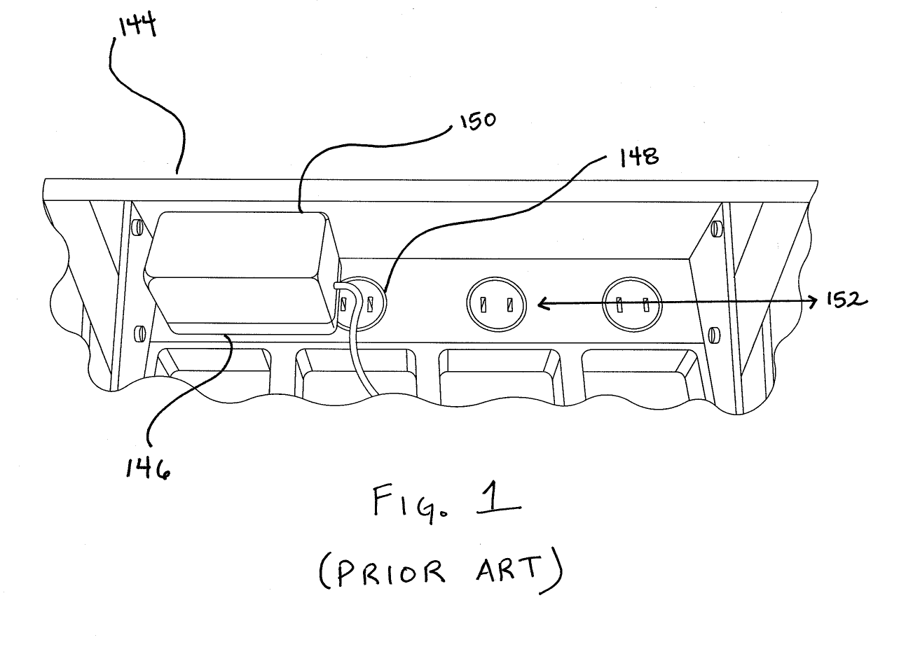

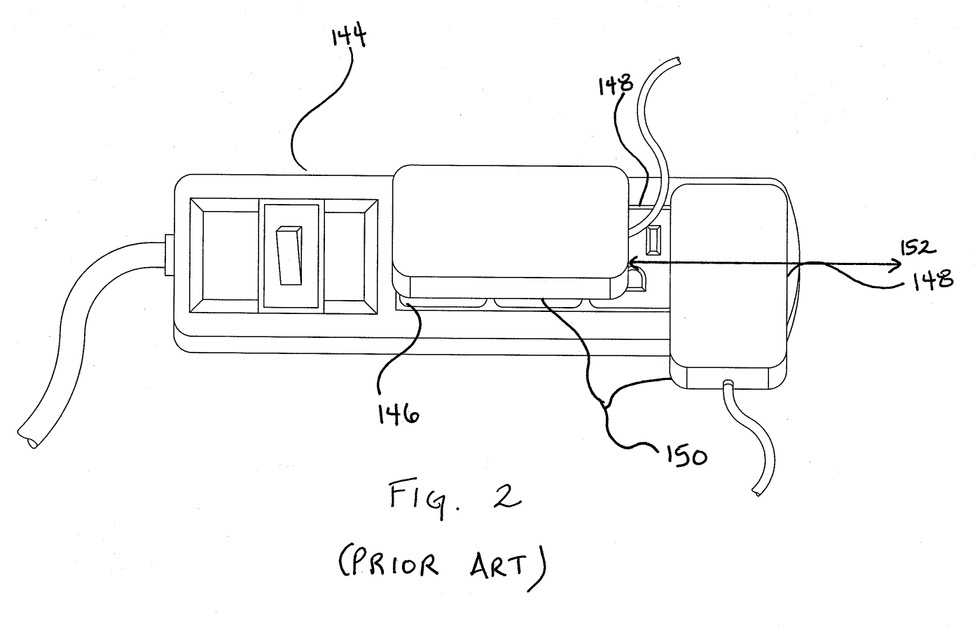

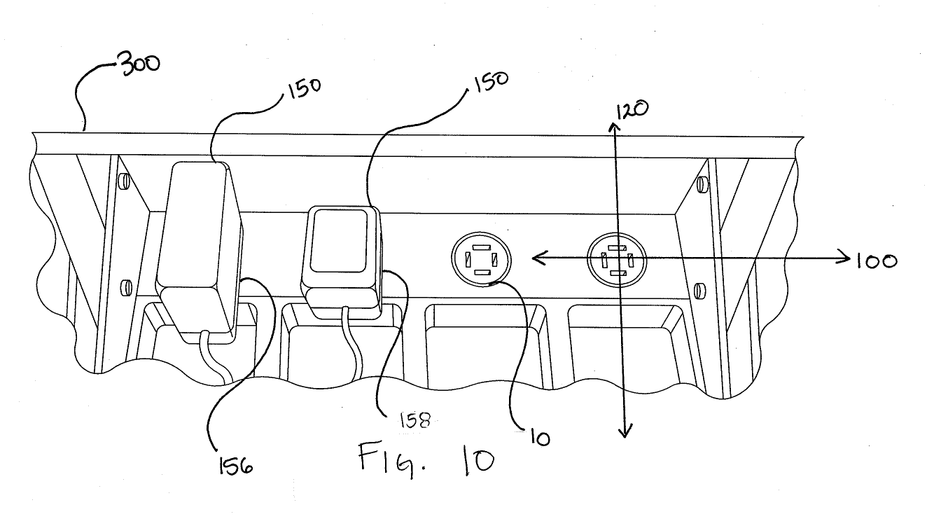

Referring to the prior art device illustrated in FIG. 1 and the present socket 10 as implemented in FIG. 10, it should be understood that the bidirectional socket 10 provides that a device plug 150 may be oriented either along a first axis 100 or along a second axis 120. It is the multiple axes 100, 120 available in positioning a non-polarized plug 150 in the bidirectional socket 10 that may prevent the insertion of a device plug 150 in a first socket 156 from blocking a neighboring socket 158, thereby optimizing the number of sockets 10 available fore receiving a device plug 150. In the prior art devices of FIGS. 1 and 2 the outlets are positioned along a single axis 152, thereby potentially restricting the positioning of the plug 150 in the first outlet 146 depending on the orientation of the plug 150 itself.

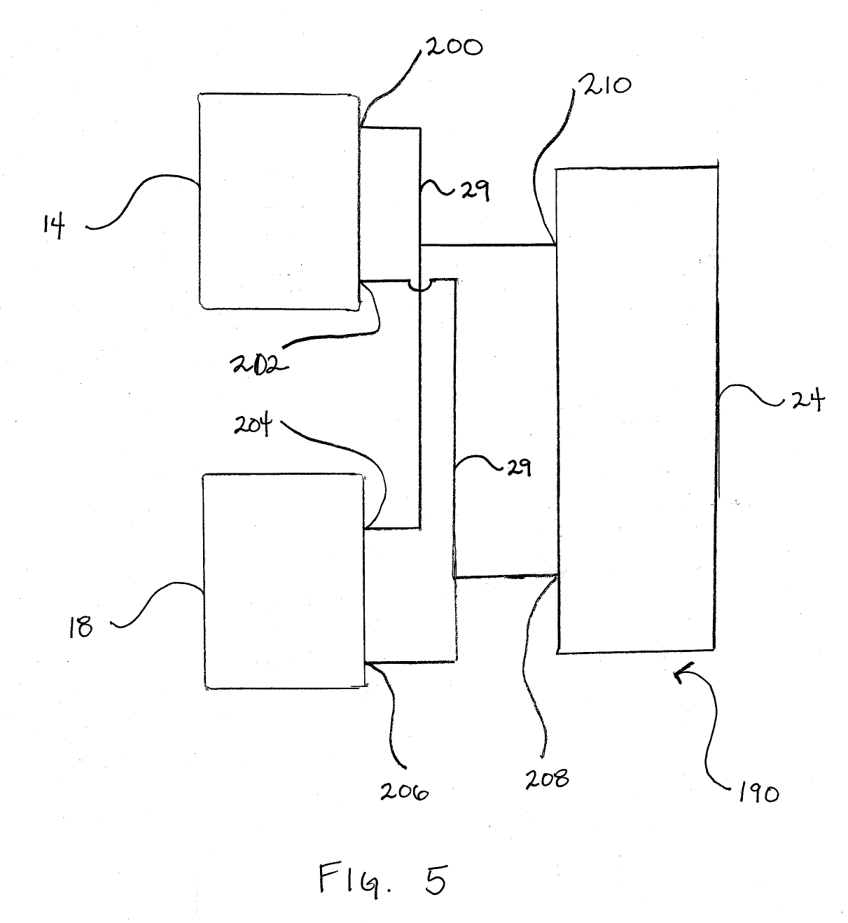

As illustrated in the schematic diagram presented in FIG. 5, each of the first pair 14 and second pair 18 of plug receptacles 15 is configured to provide an electrical connection 190 to a power source 24 and are non-polarized to provide the disclosed bidirectional functionality. In an embodiment, the electrical connection 190 provides the first pair 14 of plug receptacles 15 with a first live terminal 200 and a first return terminal 202, and the second pair 18 of plug receptacles 15 with a second live terminal 204 and a second return terminal 206. The power source 24 includes a source live terminal 210 and a source return terminal 208. The socket 10 in all embodiments may comprise wiring connectors 29 electrically coupled to each of the first pair 14 of plug receptacles 15 and the second pair 18 of plug receptacles 15 for electrical wiring to a power source 24. The first pair of plug receptacles 14 may include wiring connectors 29 independent from those of the second pair of plug receptacles 18, or the receptacles 14, 18 may be jointly wired by wiring connectors 29. Other forms of connections and connectors may be utilized as understood by those skilled in the art. Further, such electrical wiring for non-polar socket receptacles is well know to those having ordinary skill in the art for providing power to electrical devices.

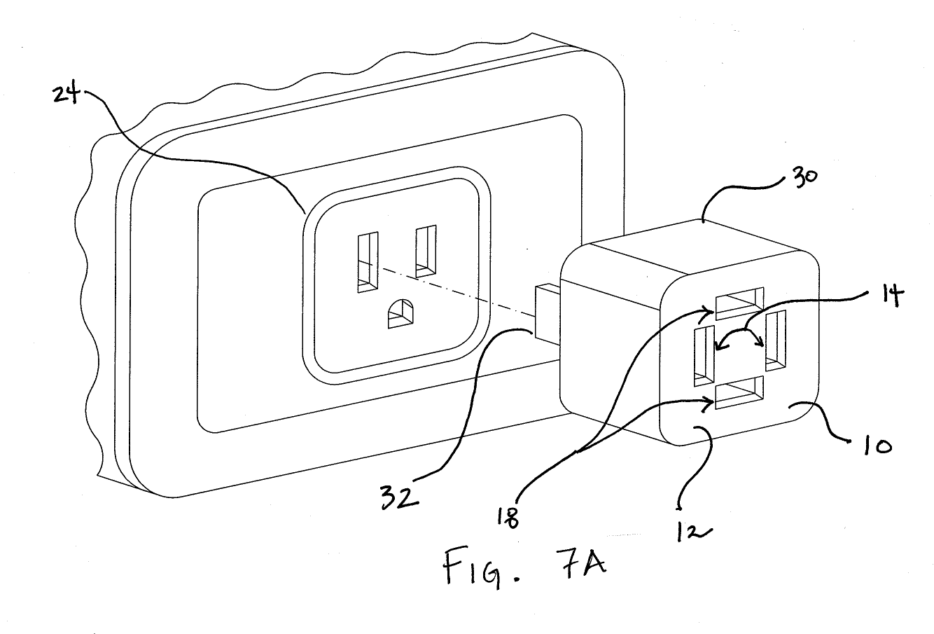

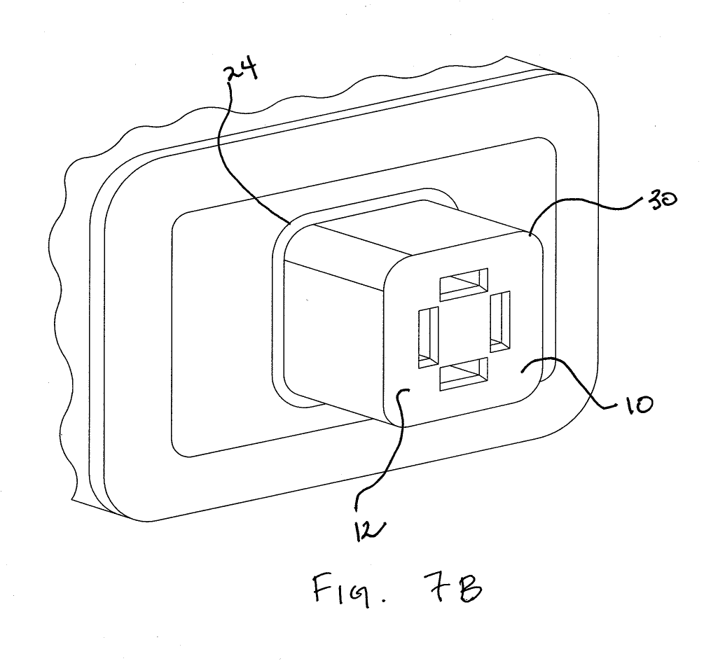

In one embodiment, the power source 24 may be an electrical box hard wired into a structure (not shown), as is known to one having ordinary skill in the art, or the power source 24 may also include a generator or other source of electrical power. In FIGS. 7A, and 7B, the power source 24 is represented by a standard electrical power outlet 24 generally found in housing or other structures and into which a user may plug a device.

Preferably and as depicted in the schematic diagram of FIG. 5, the first pair 14 and second pair 18 of plug receptacles 15 are non-polarized and do not require a ground. As is known in the art, non-polarized plug and plug receptacles do not include a ground pin and both prongs 26 are of the same size rather than one prong being larger than the other, as occurs in polarized plugs and receptacles. The provision of non-polarized plug receptacles in the instant socket 10 enables the ability to accommodate large power supply adapters or awkwardly-shaped plugs which polarized plug configurations may not be able to accommodate. Polarized plug configurations automatically impose positioning constraints because of the larger and smaller prongs and the grounding pin. Non-polarized sockets, however, may receive a non-polarized plug in multiple positions, as is illustrated in FIG. 10.

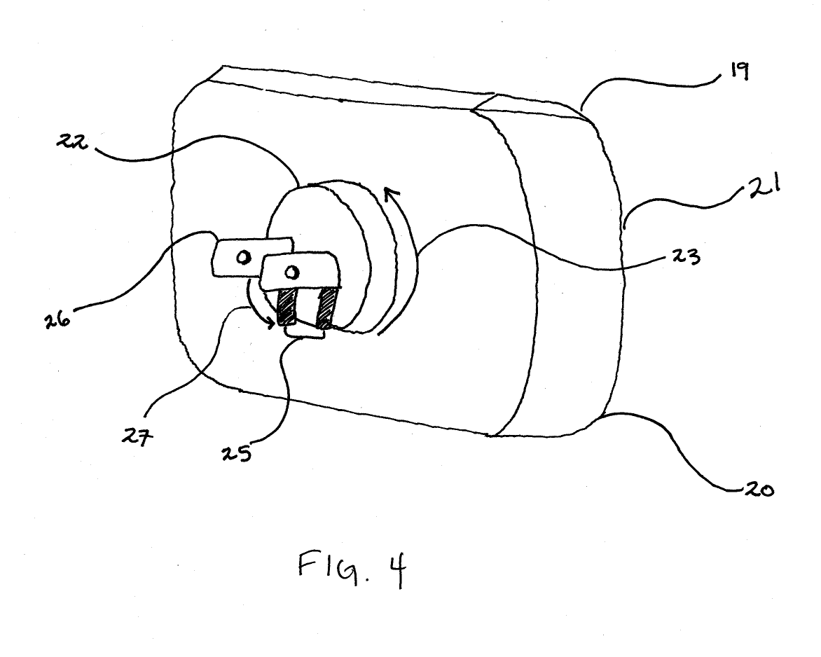

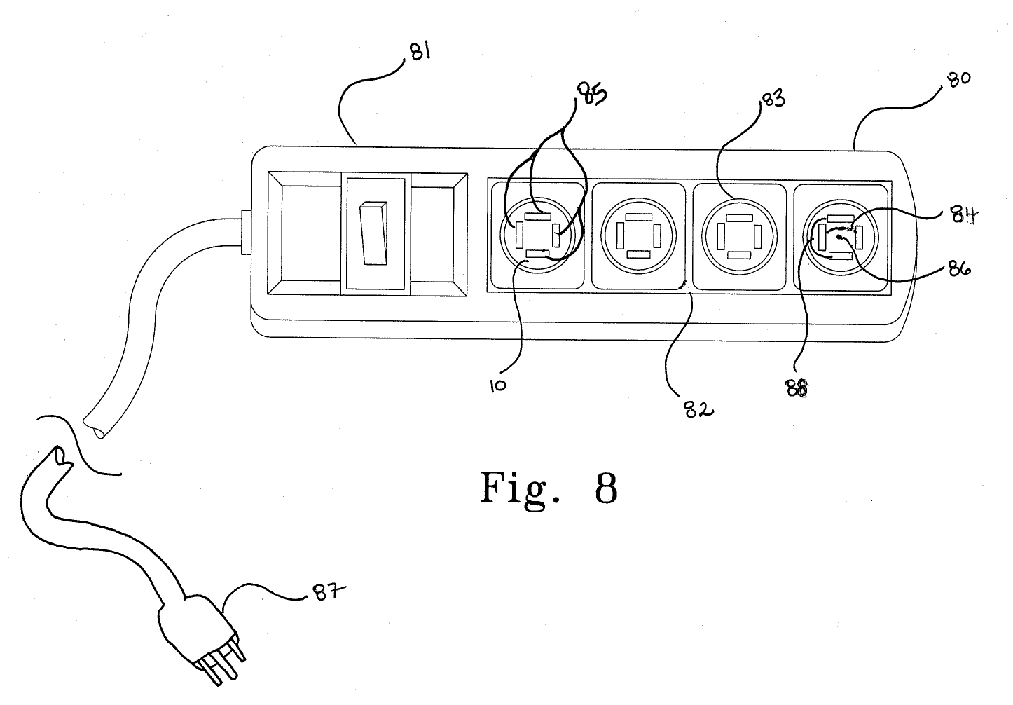

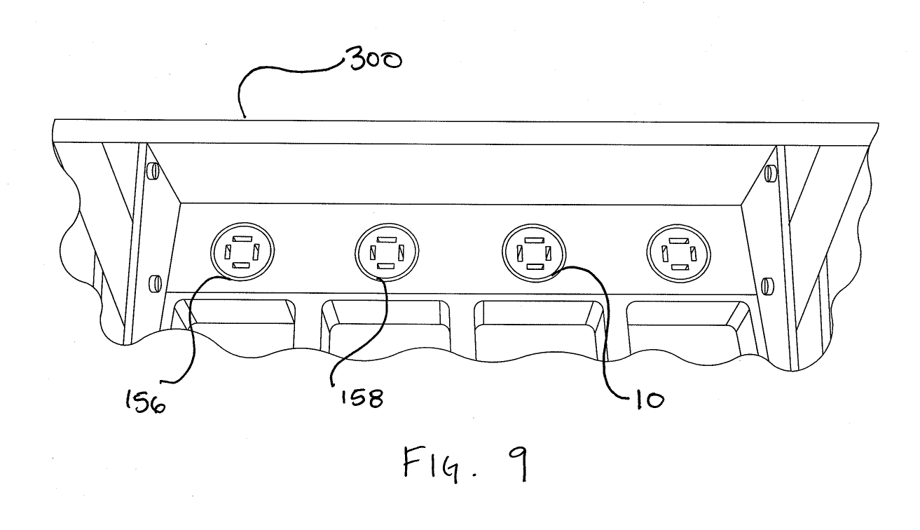

Because the socket 10 is of standard nonpolar construction as it relates to electrical wiring known in the art, the socket 10 may be used in any assembly in which an electrical socket is used. In particular, and as described herein, the socket 10 design may be integrated into a wall outlet such as that depicted in FIGS. 3 and 6 of the type typically installed in a structure and corresponding to an electrical box. Additionally, the socket 10 may be incorporated into a single-unit outlet charger 22, such as that depicted in FIG. 4, used as an adapter 30 as in FIGS. 7A and 7B, or a series of sockets 10 can be incorporated into an electrical power strip 80, as in FIG. 8. Even further, the socket may be included in an electrical station on a furniture unit or other structure 300, such as that illustrated in FIGS. 9 and 10.

Each of these embodiments is described in greater detail herein, however these particular designs are not intended to restrict the manner in which the socket 10 may otherwise be used. It is considered that the socket 10 may be incorporated into other devices or structures that require an electrical outlet enabling multiple orientations for receiving a non-polarized plug, such as in outlet extender portions, generators, light-stand workstations, or other structures. In one form, the center points 16, 17 of the first pair 14 of plug receptacles 15 and the second pair 18 of plug receptacles 15 share the same position, as will be recognized by persons having skill in the art, may be utilized in a variety of space-efficiency ways.

With regard to the embodiment of the socket 10 illustrated in FIG. 4, the socket is incorporated into a single-device charging station 19. The charging station 19 may have a housing 20 with a front face 21 onto which the socket 10 is defined. The socket 10 of the charging station 19 is bidirectional as in the other disclosed embodiments, having a first pair 14 of plug receptacles 15 and a second pair 18 of plug receptacles 15 offset and sharing a common position for first and second center points 16, 17, respectively. The charging station 19 also has a male plug 22 extending from the housing 20. The housing 20 may be of any shape to accommodate the socket 10 and the male plug 22, and provides for a compact manner of transporting the bidirectional socket 10 and retrofitting standard socket designs. In an embodiment, the male plug 22 may be operably coupled to the housing 20 opposite the face 12, the male plug 22 being configured to be received by a power outlet 24 such as that illustrated in FIG. 7A. The male plug 22 is further configured so to provide an electrical connection to the outlet, and so the plug 22 is electrically coupled to the first pair 14 of plug receptacles 15 and the second pair 18 of plug receptacles 15.

In one configuration, the male plug 22 of the charging station 19 may be rotatable with respect to the housing 20, along a direction of rotation represented by, for example, arrow 23. This allows the station 19 to be held in the necessary orientation, regardless of the power outlet 24 configuration (i.e., vertical outlets vs. horizontal outlets). Additionally, the prongs 26 of the male plug 22 may be retractable along the movement represented by arrow 27, the prongs 26 being received in recesses 25. Again, by allowing the prongs 26 to fold or retract, storage and/or carrying of the charging station 19 is made easier.

Additionally, and as depicted in FIG. 6, the face 62 may have defined therewithin a plurality of receptacle sets 61, with each receptacle set 61 comprising a first pair 14 of plug receptacles 15 and second pair 18 of plug receptacles 15. Although FIG. 6 depicts the plurality of receptacle sets 61 arranged in a block, the receptacle sets 61 may otherwise be arranged linearly or in other configurations where the first pair 14 and second pair 18 of plug receptacles are offset, as would be understood by those having skill in the art.

The bidirectional socket 10 is illustrated in FIG. 7A as being an adapter 30, with FIG. 7B illustrating the adapter 30 installed in power outlet 24. The adapter 30 may include a male plug 32, similar to that provided on the outlet charger 22 depicted in FIG. 4, for insertion into and electrical coupling to power outlet 24. It is to be understood that the first pair 14 and second pair 18 of plug receptacles 15 are, accordingly, electrically coupled to the power source 24. The socket 10 as an adapter 30 provides for a means of converting a traditional electrical socket into one in which devices may be plugged in a variety of orientations, thereby accommodating more device plugs and avoiding the blockage resulting from standard outlet orientation.

The implementation of the socket 10 in FIG. 8 provides the same benefits of the embodiments previously described, but is included in an electrical power strip 80 having a plurality of receptacle sets 83. As previously described, each receptacle set is comprised of a first pair 84 of plug receptacles 85 and a second pair 88 of plug receptacles 85. The electrical power strip 80 includes a housing 81 on which an outlet face 82 is disposed, the receptacle sets 83 defined within the outlet face 82. In one form, the socket 10 is characterized by the first pair 84 of plug receptacles 85 and the second pair 88 of plug receptacles 85 being perpendicular to each other and sharing a common center point 86. A male plug 87 extends from the housing 81 for providing electrical connection to a power source, as previously described. The electrical power strip 80 may, in an embodiment, be an adapter providing for a plurality of bidirectional sockets 10 to be directly inserted into a standard electrical outlet, thereby converting the standard outlet into a series of bidirectional sockets 10.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of applicants' contribution. The actual scope of the protection sought is intended to be defined in the following claims when viewed in their proper perspective based on the prior art.

What is claimed is:

1. An electrical socket comprising:
a face;
a first pair of plug receptacles defined within the face and separated by a distance having a first center point, the first pair of plug receptacles being configured to provide an electrical connection to a power source; and
a second pair of plug receptacles defined within the face, substantially perpendicular to the first pair of plug receptacles, and separated by a distance having a second center point, the second pair of plug receptacles being configured to provide an electrical connection to a power source;
wherein the first and second center points are the same point.

2. The electrical socket of claim 1, wherein the first pair and the second pair of plug receptacles are non-polarized.

3. The electrical socket of claim 1, further comprising:
a housing, the face coupled to the housing; and
a male plug for insertion to a power outlet, the male plug being operably coupled to the housing for providing an electrical connection to the outlet and being electrically coupled to the first pair and second pair of plug receptacles.

4. The electrical socket of claim 3, wherein the male plug is rotatable with respect to the housing to allow the socket to be oriented regardless of the power outlet configuration.

5. The electrical socket of claim 3, wherein the male plug is retractable to allow prongs of the plug to be collectively moved from an open and usable position to a closed position.

6. The electrical socket of claim 1, further comprising wiring connectors electrically coupled to the first pair and second pair of plug receptacles for electrical wiring to a power source.

7. The electrical socket of claim 1, wherein the first pair of plug receptacles and second pair of plug receptacles define a receptacle set, and wherein the face comprises a plurality of receptacle sets defined thereon.

8. The electrical socket of claim 7, wherein the plurality of sets are linearly arranged.

9. The electrical socket of claim 7, wherein the plurality of sets are arranged in a block.

10. The electrical socket of claim 1, wherein the socket is an adapter comprising a male plug for insertion to a power outlet, the male plug being electrically coupled to the outlet.

11. An electrical power strip comprising:
a housing comprising an outlet face and a male plug extending from the housing and being configured to provide an electrical connection to a power source; and
a plurality of receptacle sets, each set comprising:
a first pair of plug receptacles defined on the outlet face and separated by a distance having a first center point, the first pair of plug receptacles being configured to provide an electrical connection to the male plug; and
a second pair of plug receptacles defined on the outlet face, substantially perpendicular to the first pair of plug receptacles, and separated by a second distance having a center point, the second pair of plug receptacles being configured to provide an electrical connection to the male plug;
wherein the first and second center points are the same point.

12. The electrical power strip of claim 11, wherein the first pair and the second pair of plug receptacles are non-polarized.

13. The electrical power strip of claim 11, further comprising wiring connectors electrically coupled to the first pair and second pair of plug receptacles.

14. The electrical power strip of claim 11, wherein the plurality of sets are linearly arranged.

15. The electrical power strip of claim 11, wherein the plurality of sets are arranged in a block.

16. The electrical power strip of claim 11, wherein the electrical power strip is an adapter.

17. An electrical socket comprising:
a face;
a first pair of plug receptacles defined within the face oriented along a first axis and defining a first plug area, the first pair of plug receptacles being configured to provide an electrical connection to a power source; and
a second pair of plug receptacles defined within the face oriented along a second axis and defining a second plug area, the second axis intersecting the first axis and the second pair of plug receptacles being configured to provide an electrical connection to a power source;
wherein the first plug area overlaps the second plug area.

18. The electrical socket of claim 17, wherein each of the first pair and the second pair of plug receptacles are non-polarized.

19. The electrical socket of claim 17, wherein the first axis is perpendicular to the second axis and the first plug area substantially overlaps the second plug area.

20. The electrical socket of claim 17, further comprising wiring connectors electrically coupled to each of the first pair and second pair of plug receptacles for electrical wiring to a power source.

21. The electrical socket of claim 17, wherein the first pair of plug receptacles and second pair of plug receptacles define a receptacle set, and wherein the face comprises a plurality of receptacle sets defined thereon.
